(19) United States
(12) Patent Application Publication
(10) Pub. No.: US 2010/0327115 A1
(43) Pub. Date: Dec. 30, 2010

(54) AIRCRAFT POD STORE SEPARATION CHARACTERISTICS

(76) Inventors: Alexis Cenko, Dunkirk, MD (US); Eric Hallberg, Annapolis, MD (US); William Godiksen, Pensacola, FL (US)

Correspondence Address: Department of the Navy;(Naval Air Warfare Center -Aircraft Division), 47076 Lijencreantz Road, B 435, PATUXENT RIVER, MD, 20670, US

(21) Appl. No.: 12/433,142

(22) Filed: Apr. 30, 2009

(51) Int. Cl. B64C 1/38

(52) U.S. Cl. 244/130

(57) ABSTRACT

A method for modifying the flow field about an aircraft instrumentation pod to improve the separation characteristics of stores released from adjacent pylons includes measuring the flow field about the aircraft instrumentation pod to obtain measured flowfield data, examining the flowfield data measured about the aircraft instrumentation pod to detect regions of supercritical flow, analyzing the measured flowfield data to determine one or more causes for detected regions of supercritical flow about the instrumentation pod, and modifying the geometry of the instrumentation pod to reduce the effects of the any supercritical flow fields. In one application of the inventive method, the trailing end of an instrumentation pod was modified from a tapered end to form an ogive which reduced shocks formed about the pod at transonic speeds that interfered with the trajectory of stores released from adjacent pylons.

### GOVERNMENT INTEREST

The invention described herein may be manufactured, licensed, and used by or for the U.S. Government.

### BACKGROUND

The United States Navy uses a variety of outboard instrumentation pods that are mounted underneath the wings or fuselage of high performance aircraft. Instrumentation pods, for example, the Targeting Forward Looking Infrared Pod (TFLIR), the Advanced Targeting Forward Looking Infrared Pod (ATFLIR), Litening pod, and the like, are frequently positioned in close proximity to pylons holding stores that are released from the aircraft in the course of performing a mission.

Although instrumentation pods were initially though to have negligible effect on the flow dynamics of the aircraft, this has turned out to be incorrect. During a routine F/A-18C practice mission, while the aircraft was at transonic speed, a MK-82 bomb was released from an inboard wing pylon adjacent to a TFLIR instrumentation pod. The nose of the MK-82 unexpectedly yawed away from the fuselage causing its tail fins to impact the TFLIR. Upon further investigation, similar aerodynamic behavior was observed for stores released from inboard wing pylons adjacent to the ATFLIR and Litening instrumentation pods. Although flight tests subsequently established safe store release operating conditions for aircraft equipped with these instrumentation pods, the full operating envelope of the F/A-18 was necessarily restricted for a number of commonly used store/pod configurations. Embodiments according to the invention are directed to methods and apparatuses for improving separation characteristics of stores released from aircraft equipped with instrumentation pods including, but not limited to, the ATFLIR, TFLIR and Litening pods.

### SUMMARY

In general, in one aspect of the present invention, an embodiment of a method for modifying a flow field about an aircraft instrumentation pod to improve separation characteristics of stores released from adjacent pylons includes measuring the flow field about the aircraft instrumentation pod to obtain measured flowfield data, examining the measured flowfield data to detect regions of supercritical flow that may affect the trajectory of the stores released from adjacent pylons, analyzing the measured flowfield data to determine one or more causes for the detected regions of supercritical flow about the aircraft instrumentation pod, and modifying the geometry of the aircraft instrumentation pod to reduce the effects of the detected regions of supercritical flow.

In another aspect according to the present invention, an instrumentation pod for positioning under the fuselage of an aircraft includes an elongate body having a nose and a tail, wherein the tail of the instrumentation pod is formed substantially in the shape of an ogive to reduce regions of supercritical flow about the instrumentation pod that affect the trajectory of a store released from an adjacent pylon.

### BRIEF DESCRIPTION OF THE DRAWINGS

Exemplary embodiments according to the invention are illustrated in the accompanying drawings in which like reference numerals represent like parts throughout and in which:

FIG. 1 is a perspective partial view illustrating an F/A-18 supersonic fighter aircraft with an instrumentation pod docked in an instrumentation pod station in the underbody of the fuselage and a store attached to an adjacent inboard pylon;

FIG. 2A is a side view diagram of a conventional TFLIR docked in an instrumentation pod station mounted in the underbody of an aircraft fuselage;

FIG. 2B is a top view diagram of the TFLIR shown in FIG. 2A;

FIG. 3A is a side elevation view diagram of a conventional ATFLIR docked in an instrumentation pod station mounted in the underbody of an aircraft fuselage;

FIG. 3B is a top view diagram of the ATFLIR shown in FIG. 3A;

FIG. 4 is a graph showing a comparison of the miss distances of an MK-84 store released from an inboard wing pylon of an F/A-18 aircraft with an adjacent TFLIR, an adjacent ATFLIR, and no instrumentation pod mounted on the aircraft;

FIG. 5 is a graphical representation of a shock wave pattern generated by a computational fluid dynamic study of the underside of an F/A-18 aircraft equipped with an ATFLIR instrumentation pod and a Litening instrumentation pod and stores mounted on adjacent inboard wing pylons;

FIG. 6 is a graph showing instantaneous air pressures at the surface of the underbody of an F-18 having an unmodified ATFLIR docked in the right side instrumentation pod station and an ATFLIR that has been modified according to an embodiment of the present invention docked in the left side instrumentation pod station;

FIG. 7A is an isometric view of an instrumentation pod that has been modified in accordance with an embodiment of the invention; and

FIG. 7B is a side view if the instrumentation pod shown in FIG. 7A.

### DETAILED DESCRIPTION

In the following detailed description, reference is made to the accompanying drawings which are a part of this patent disclosure, and in which are shown by way of illustration specific embodiments in which the invention, as claimed, may be practiced. This invention may, however, be embodied in many different forms and should not be construed as limited to the embodiments set forth; rather, these embodiments are provided so that this disclosure will be thorough and complete, and will fully convey the scope of the invention to those skilled in the art.

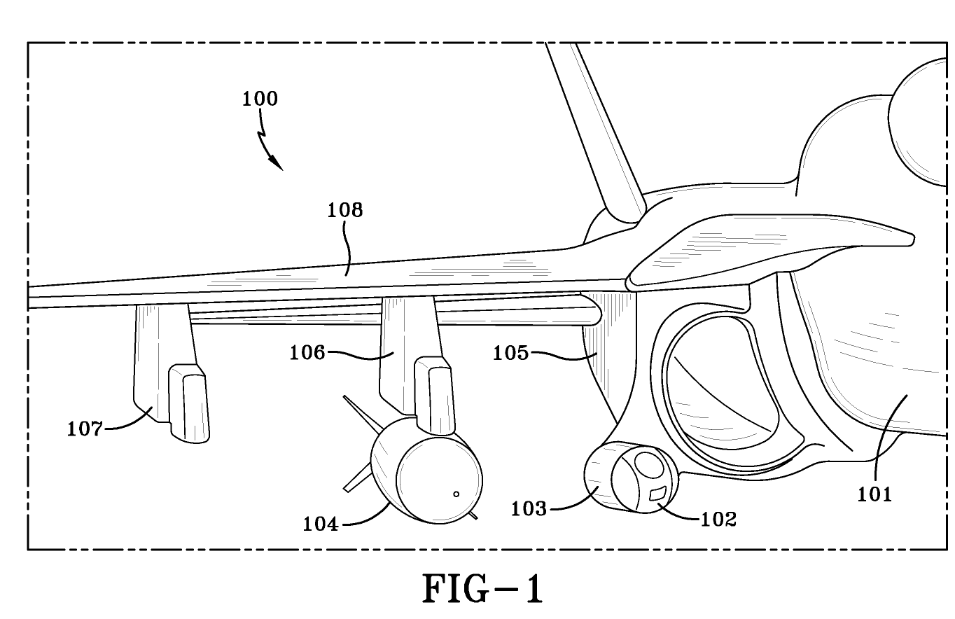

FIG. 1 shows a perspective view of a portion of the right side of an F/A-18 fighter aircraft 100. Aircraft 100 includes a fuselage 101 (shown partially in this view), a right engine air intake 105 extending from fuselage 101, a right wing 108 extending angularly from fuselage 101 and substantially over right air intake 105, a right wing outboard pylon 107, and a right wing inboard pylon 106 from which is hung a store 104. A right side instrumentation pod station 103 is mounted on the underside of the fuselage of aircraft 100 such that an instrumentation pod 102 mounted therein is substantially adjacent to store 104 and pylon 106.

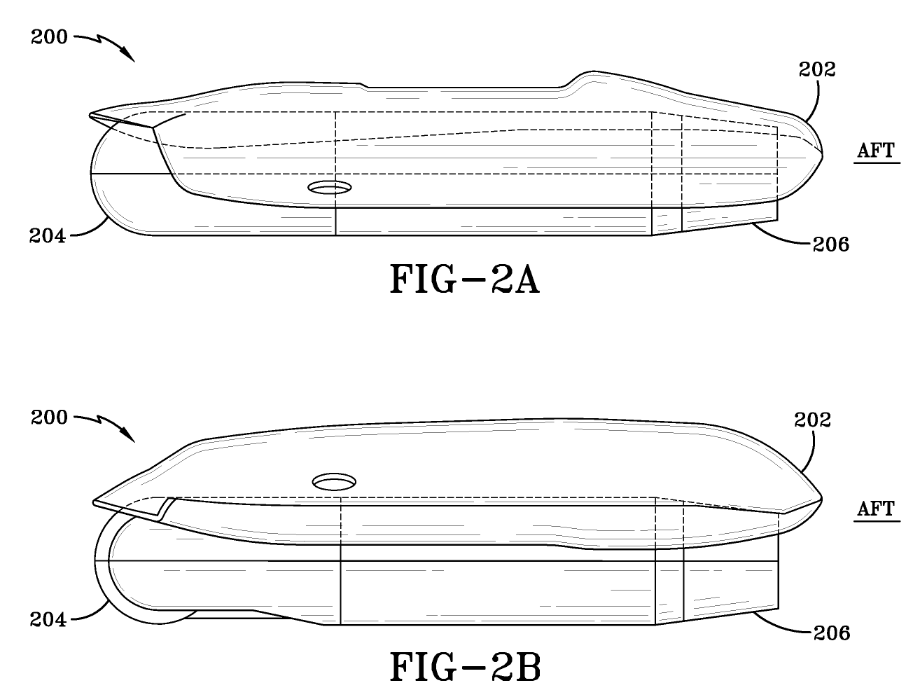

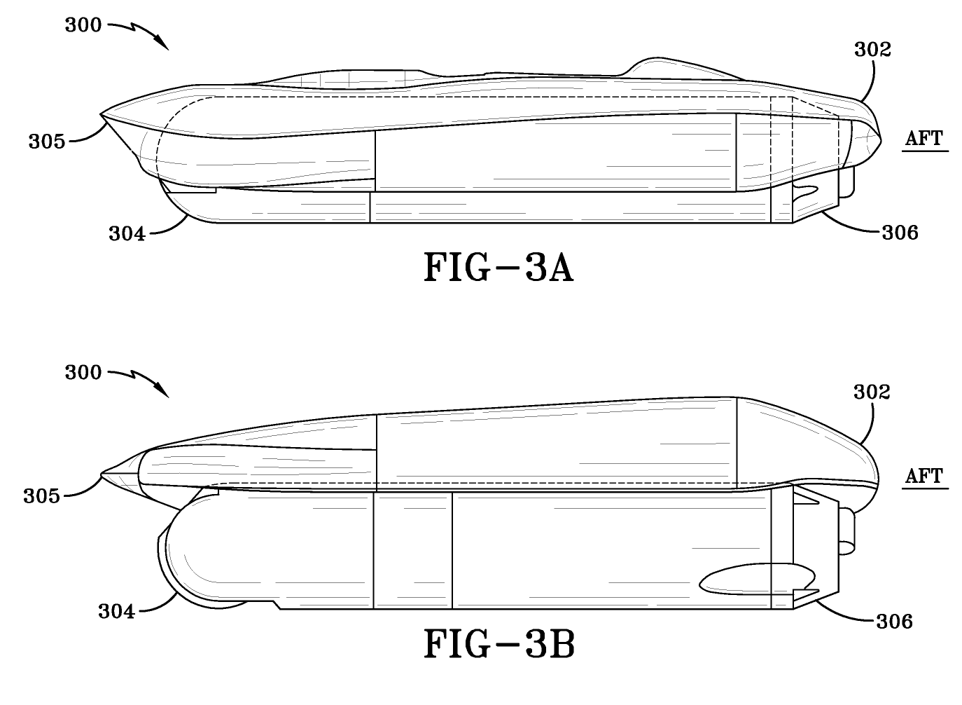

FIGS. 2A and 2B show top and side views, respectively, of a TFLIR instrumentation pod 200 docked in an instrumentation pod station 202 in the underbody of an F/A-18 aircraft (not shown). TFLIR instrumentation pod 200 includes a forward end 204 and an aft end 206. FIGS. 3A and 3B show top and side view diagrams, respectively, of an ATFLIR instrumentation pod 300 mounted in a docking station 302 in the underbody of an F/A-18 aircraft. ATFLIR instrumentation pod 300 includes a forward end 304 and an aft end 306. Dashed lines are used to represent features that would be hidden from view in the figures. In most respects, TFLIR instrumentation pod 200 and ATFLIR instrumentation pod 300 are similar in appearance, the most noticeable difference being the presence of an elongated fairing 305 that extends over the nose of ATFLIR instrumentation pod 300. While differences in the geometry of the trailing ends of TFLIR instrumentation pod 200 and ATFLIR instrumentation pod 300 are less pronounced, they make a substantial difference in the aircraft's flowfield and aerodynamic performance at transonic speeds. In particular, the principal geometric difference between aft end 306 of ATFLIR 300 and aft end 206 of TFLIR 200 is that aft end 306 has a sharply tapered “boat tail” end, while aft end 206 is comparatively straight. Computational flow dynamic tests revealed that the tapered boat tail of aft end 306 accelerates the flow just prior to the blunt back end of instrumentation pod 300. This exacerbates shock formation (i.e., areas of super critical flow) about aft end 306 at transonic speeds.

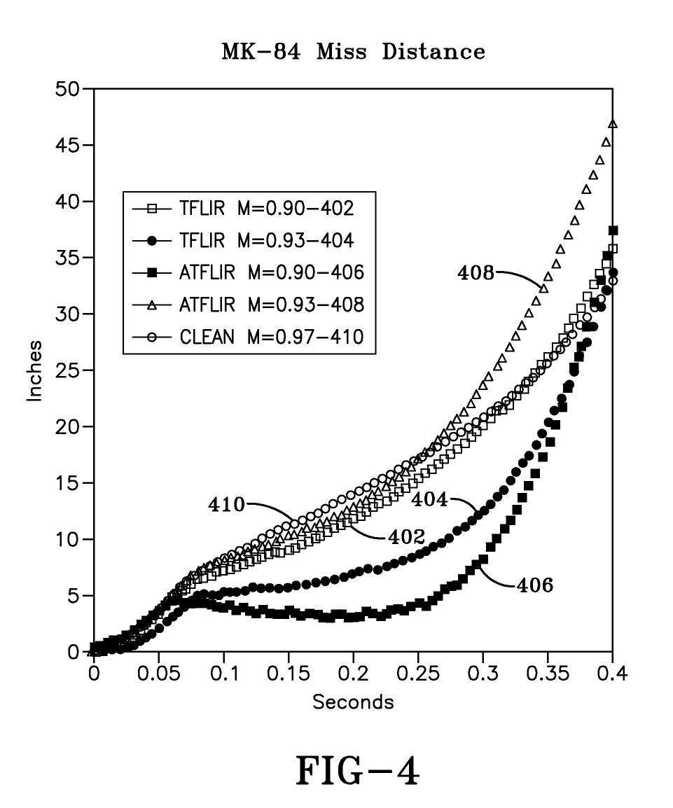

FIG. 4 shows a comparison graph of data sets of store miss distances for releases of MK-84s from an inboard wing pylon adjacent to one of several different instrumentation pods on the F/A-18. The MK-84 is a standard, low-drag, general purpose, free-fall, non-guided, 2000-pound bomb, cylindrical in shape with a tapered nose and tail and equipped with tail fin assemblies. At approximately 129 inches in length it is substantially longer than both ATFLIR instrumentation pod and the Litening instrumentation pod. At speeds between Mach 0.90 and 0.95, a comparison of flight test results showed significant differences in the trajectories immediately after stores were dropped from the station adjacent to TFLIR instrumentation pod versus those dropped from the station adjacent to the ATFLIR instrumentation pod. Data sets 402 and 404 show the miss distances of an MK-84 dropped an inboard wing pylon adjacent TFLIR instrumentation pod at speeds of Mach 0.90 and 0.93, respectively, and data sets 406 and 408 show the miss distances of an MK-84 dropped an inboard wing pylon adjacent an ATFLIR instrumentation pod at speeds of Mach 0.90 and 0.93, respectively. Data set 410 shows the miss distance of an MK-84 dropped from an inboard wing pylon with no instrumentation pod attached at a speed of Mach 0.97.

For no instrumentation pod attached, as data set 410 demonstrates, the miss distance continuously increases with time. At M=0.90, the miss distances for the TFLIR equipped F/A-18 (data set 402) and the ATFLIR equipped F/A-18 (data set 406) also increase more or less continuously with time. However, at M=0.93, the minimum miss distance is considerably less for the ATFLIR equipped F/A-18 (data set 408) than for the TFLIR equipped F/A-18 (data set 404) to such an extent that the F/A-18 with an ATFLIR was restricted to a lower Mach number limit for release of an MK-84 than for an F/A-18 equipped with the less advanced TFLIR.

An additional study was conducted to determine the Mach number limits for the

MK-84 with a Litening instrumentation pod attached to the fuselage of the F/A-18. The Litening instrumentation pod is larger than the TFLIR or ATFLIR and thus it was anticipated that an even lower Mach number restriction would likely be required. Unexpectedly, the MK-84 trajectory with the Litening instrumentation pod in place was more benign than for the ATFLIR, and no special restrictions were imposed for this configuration.

To better understand the store release trajectory problem caused by the ATFLIR, a series of Computational Flow Dynamic (CFD) studies were next undertaken. A very large amount of data must be processed to conduct meaningful CFD studies of aircraft in transonic flight regimes.

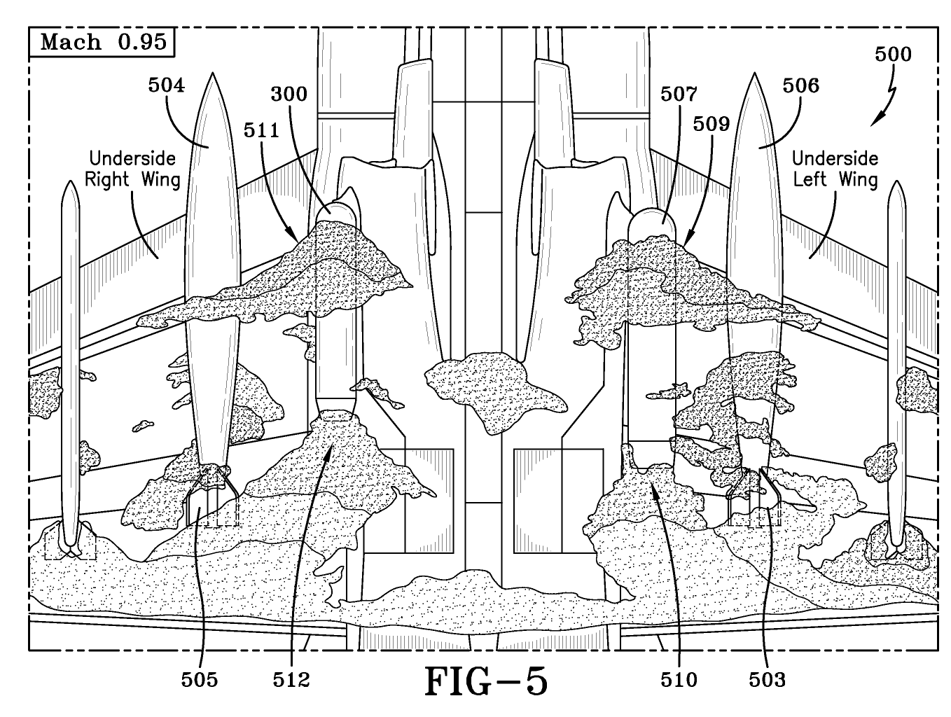

FIG. 5 shows a computer generated graphic of a CFD study depicting flowfield and shock formation on the underbelly 500 of an F/A-18 in a transonic flight regime (Mach 0.95). In this CFD study, GBU-31 stores 504 and 506 are mounted to right and left inboard pylons, respectively. An ATFLIR instrumentation pod 300 is mounted on a right instrumentation pod station adjacent GBU-31 store 504 and a Litening instrumentation pod 507 is mounted on a left instrumentation pod station adjacent a GBU-31 store 506. Shock wave flowfields 511 and 509 emanate from the fore ends of ATFLIR 300 and Litening instrumentation pod 507, respectively, and impinge on adjacent stores 504 and 506. Because shocks 511 and 509 impact the stores close to their centers of gravity (CG) the moments are small and have little influence on the trajectory of the stores when they are released. Shock wave flowfields 510 and 512 emanate from the tail ends of Litening Instrumentation pod 507 and ATFLIR 300, respectively. Shock wave flowfield 512 extends rearwardly and outwardly from the shorter ATFLIR instrumentation pod 300 and, as can be seen, clearly impinges on the tail of the adjacent GBU-31 504. Hitting the tail of GBU-31 504 aft of its CG imparts a significant moment on the store and greatly influences the trajectory of the store. Since Litening instrumentation pod 507 is significantly longer than ATFLIR instrumentation pod 300, no significant part of shock wave flowfield 510 impinges on GBU-31 506.

In addition to the disturbances caused to adjacent stores, the unaltered ATFLIR and TFLIR instrumentation pods significantly raise the overall aircraft drag. For example, the TFLIR raises the total F/A-18 aircraft drag by 35 counts (a coefficient of drag (C_{D}) of 0.001 is one drag count). This requires 1700 pounds of thrust at sea level at M=0.95. Any drag reduction will enhance the performance characteristics of the F/A-18.

Although the TFLIR and ATFLIR are similar in size and shape, as can be seen in

FIGS. 2 and 3, ATFLIR 300 has a more sharply tapered tail (a “boat tail”) than TFLIR 200. As FIG. 5 shows, a large shock emanates from the blunt aft end of ATFLIR 300 and impinges on the adjacent store. The ATFLIR 300 boat tail actually accelerates the flow field aft of the instrumentation pod and exacerbates the resultant shock. Litening instrumentation pod 507, which has a constant cross section as well as a scoop at the aft end, does not accelerate the flow field nearly as much as ATFLIR 300, which helps explain its more benign effect on adjacent stores.

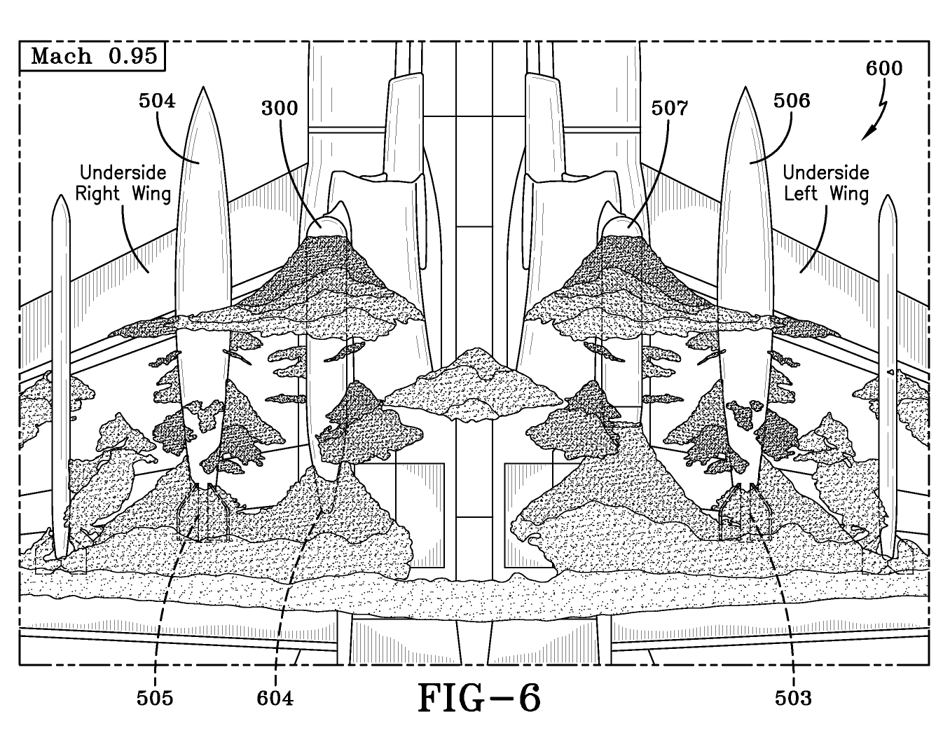

After evaluating the information from the CFD studies, changes to the aft end of the instrumentation pods that cause store separation difficulties were devised. FIG. 6 is a computational fluid dynamic study showing the aerodynamic pressure flow about the underside of an F/A-18 aircraft 600 equipped with an ATFLIR 300 under the right wing having a 30 inch ogive tail extension 604, and an unmodified ATFLIR 300 under the left wing. As in FIG. 5, GBU-31 stores 504 and 506 are mounted on the right and left inboard pylons, respectively, adjacent to the instrumentation pods. As FIG. 6 demonstrates, the ATFLIR 300 with the ogive extension 604 considerably improves the flowfield about the aft end.

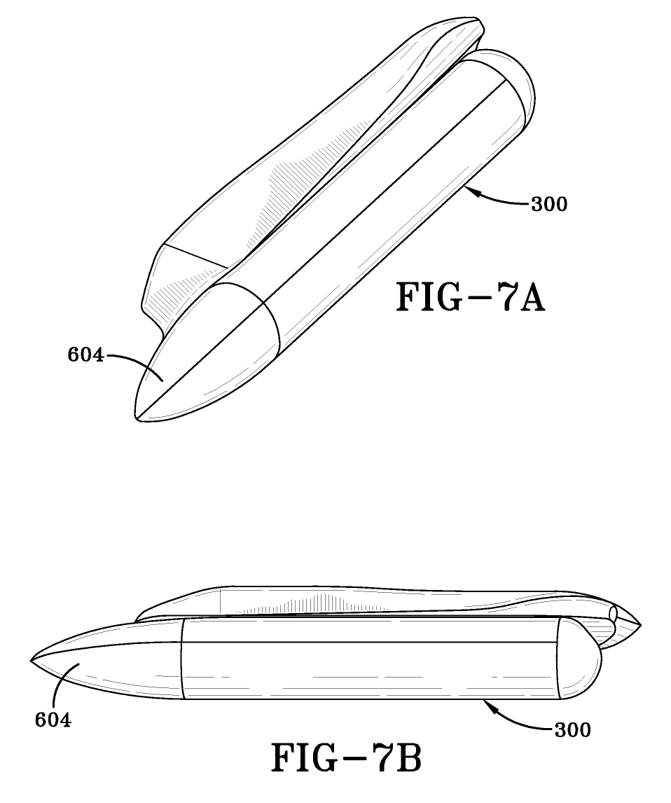

FIGS. 7A and 7B show isometric and side views of an ATFLIR instrumentation pod 300 that has been equipped with a tail extension 604 to improve the flowfield about the instrumentation pod. Tail extension 604 is a tapered cylinder having a diameter equal to the diameter of the ATFLIR forward of the boat tail and approximately 30 inches in length. While improved performance and reduced interference with adjacent stores will result from a variety of elongate aerodynamic extensions, in the preferred embodiment, tail extension 604 forms a Sears Haack ogive, since that type of shape produces minimum drag. Tail extension 604 may be fit to existing instrumentation pods such as the TFLIR and ATFLIR and may be releasably attached by suitable fasteners, for example, bolts or screws, or may be permanently attached to the pods by rivets and/or an adhesive. Tail extension 604 may be made of any suitable aircraft material, for example, fiberglass, aluminum or titanium. In alternative embodiments, a tail extension according to the present invention may be integrated into the design of next generation instrumentation pods.

### CONCLUSION

As has been shown, embodiments according to the invention effectively modify the flow field about an aircraft instrumentation pod to reduce the effects of regions of supercritical flow that adversely affect the trajectory of a store released from an adjacent pylon. Accordingly, the scope of the invention should be determined by the following claims and their legal equivalents.

What is claimed is:

1. A method for modifying a flow field about an aircraft instrumentation pod to improve separation characteristics of stores released from adjacent pylons, comprising:
measuring the flow field about the aircraft instrumentation pod to obtain measured flowfield data;
examining the measured flowfield data to detect regions of supercritical flow that may affect the trajectory of the stores released from adjacent pylons;
analyzing the measured flowfield data to determine one or more causes for the detected regions of supercritical flow about the aircraft instrumentation pod; and
modifying the geometry of the aircraft instrumentation pod to reduce the effects of the detected regions of supercritical flow.

2. The method of claim 1, further comprising:
measuring the flowfield data for stores positioned adjacent to the aircraft instrumentation pod.

3. The method according to claim 1 wherein modifying the geometry of the aircraft instrumentation pod to reduce the effects of the detected regions of supercritical flow comprises forming a tail portion of the aircraft instrumentation pod substantially in the shape of an ogive.

4. The method according to claim 3 wherein the ogive comprises a Sears-Haack ogive.

5. The method according to claim 4 wherein the forming a tail portion of the aircraft instrumentation pod substantially in the shape of an ogive comprises forming a tail extension that may be fit to existing instrumentation pods.

6. An instrumentation pod for positioning under the fuselage of an aircraft, comprising:
an elongate body having a nose and a tail, wherein the tail of the instrumentation pod is formed substantially in the shape of an ogive to reduce regions of supercritical flow about the instrumentation pod that affect the trajectory of a store released from an adjacent pylon.

7. The instrumentation pod according to claim 6, wherein the ogive comprises a Sears Haack ogive.

8. The instrumentation pod according to claim 6, wherein the instrumentation pod comprises a TFLIR.

9. The instrumentation pod according to claim 6, wherein the instrumentation pod comprises an ATFLIR.

10. The instrumentation pod according to claim 6, wherein the instrumentation pod comprises a Litening pod.
